(19) United States
(12) Patent Application Publication
(10) Pub. No.: US 2014/0174899 A1
(43) Pub. Date: Jun. 26, 2014

(54) KEYBOARD EQUIPPED WITH ILLUMINATED KEYCAPS

(71) Applicant: ZIPPY TECHNOLOGY CORP., New Taipei City (TW)

(72) Inventor: Chin-Hsiu HWA, New Taipei City (TW)

(73) Assignee: ZIPPY TECHNOLOGY CORP., New Taipei City (TW)

(21) Appl. No.: 13/727,270

(22) Filed: Dec. 26, 2012

(51) Int. Cl. H01H 13/70

(52) U.S. Cl. CPC H01H 13/70
USPC 200/314

(57) ABSTRACT

A keyboard equipped with illuminated keycaps mainly includes a keyboard portion and a plurality of lighting units. The keyboard portion includes a circuit board with a plurality of keyboard command portions, a plurality of keycaps respectively corresponding to the keyboard command portions and a plurality of elastic support members located between the circuit board and keycaps are depressed by the keycaps to trigger the keyboard command portions. The keycaps and elastic support members form a light emitting zone. The lighting units correspond respectively to each of the keycaps. Each of the lighting units includes a light emitting chip located on the circuit board, a package layer covering the light emitting chip and a light mask layer locally disposed on the package layer to mask light from the light emitting chip towards the abutting keycap such that the light is confined to generate illumination merely in the light emitting zone.

### FIELD OF THE INVENTION

The present invention relates to a keyboard equipped with illuminated keycaps and particularly to a keyboard including a plurality of lighting units respectively corresponding to an individual keycap to generate illumination thereof.

### BACKGROUND OF THE INVENTION

Computers almost have become necessities in people's life nowadays. Keyboards are indispensible input equipment in computers. To allow the computers to be used in varying environments, many types of illuminated keyboards have been developed on the market, such as U.S. Pat. Nos. 6,648,530, 7,589,292, 7,531,764 and 6,860,612. They all disclose a keyboard equipped with a light emitting module to provide illumination in dim or dark environment. In order to make illumination uniform, the light emitting module in the keyboard usually includes a light guide plate to transmit light emitted from the light emitting element. However, the prevailing trend of the computer at present pursues compact, the presence of the light guide plate increases total thickness of the keyboard and makes slim and lightweight of the keyboard not possible. Moreover, this kind of keyboard also requires complicated alignment during assembly that makes fabrication process more complex.

In view of the aforesaid problems, Applicant has proposed another type of illuminated keyboard in R.O.C. publication No. 201115609 in which a light emitting strip is provided in a movable space. The light emitting strip has an opaque zone and a transparent zone through which light projects to keycaps. The light emitting strip is located locally in the movable space, hence the space occupied by the conventional light emitting plate can be saved. As a result, the keyboard can be made thinner and the weight thereof is lighter. However, as illumination uniformity of the light emitted from the illuminated keyboard is determined by the light transmission characteristic of the light guide strip. In the event that the light transmission characteristic of the light guide strip is poorer, the keyboard cannot provide uniform illumination that some portions could be too bright or some portions could be too dark. To overcome the aforesaid problem, the light emission structure of the keyboard still has room for improvement.

### SUMMARY OF THE INVENTION

The primary object of the present invention is to overcome the problem of the conventional illuminated keyboards of emitting light unevenly or too bright of the light to harsh user's eyes.

To achieve the foregoing object, the present invention provides a keyboard equipped with illuminated keycaps. It mainly comprises a keyboard portion and a plurality of lighting units. The keyboard portion includes a circuit board with a plurality of keyboard command portions, a plurality of keycaps respectively corresponding to the keyboard command portions and a plurality of elastic support members located between the circuit board and keycaps and depressed by the keycaps to trigger the keyboard command portions. The keycaps and elastic support members jointly form a light emitting zone. Each of the lighting units corresponds to one keycap and includes a light emitting chip located on the circuit board, a package layer covering the light emitting chip and a light mask layer locally disposed on the package layer to mask light from the light emitting chip towards the abutting keycap so that the light is confined to generate illumination, merely in the light emitting zone.

In one embodiment the circuit board further includes an upper film, a lower film and a middle film located between the upper film and lower film. More specifically, the lighting unit can be selectively located on the upper film, the lower film or the middle film. In the event that the lighting unit is located on the middle film, the upper film includes a plurality of first apertures respectively corresponding to the lighting units for holding the light emitting chips; in the event that the lighting unit is located on the lower film, the upper film includes the first apertures and the middle film includes a plurality of second apertures respectively corresponding to the lighting units and communicating with the first apertures for holding the lighting units.

In another embodiment the circuit board includes a reflective layer to confine the lighting units to project light merely to the light emitting zone.

In yet another embodiment the light mask layer is made of an opaque material or a reflective material; the package layer is formed in a circular or polygonal cross section in a vertical direction.

In yet another embodiment the elastic support members are made of a light transmission material.

In yet another embodiment each of the keycaps includes a transparent zone and an opaque zone.

In yet another embodiment the keyboard portion includes a plurality of driven mechanisms to respectively support the keycaps and depressed by the keycaps, and a support board to hold the driven mechanisms. More specifically, the circuit board is located above or below the support board which includes a plurality of openings respectively corresponding to the lighting units.

The keyboard equipped with illuminated keycaps according to the invention, compared with the conventional illuminated keyboards, has the following features:

1. Simpler structure. The keyboard of the invention does not have the light emitting plate or light emitting strip, hence the keyboard structure is simplified and can be made thinner, and the fabrication process also can be simplified.

2. Uniform illumination of the keyboard. In the keyboard of the invention, the lighting units correspond respectively to each of the keycaps, and the light mask layer confines light to merely project to the corresponding keycap, hence the keycaps are illuminated evenly without having some portions too bright or some portions too dark. On the other hand, the light mask layer also can make light projection concentrated without scattering excessively that might cause uneven illumination of the entire keyboard.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a first embodiment of the keyboard equipped with illuminated keycaps of the invention.

FIG. 2 is a side view of the first embodiment of the invention.

FIG. 3A is a schematic view of the first embodiment of the invention showing the position of a light emitting chip.

FIG. 3B is a schematic view of a second embodiment of the invention showing the position of a light emitting chip.

FIG. 3C is a schematic view of a third embodiment of the invention showing the position of alight emitting chip.

FIG. 4 is a schematic view of a fourth embodiment of the invention showing the position of a light emitting chip.

FIG. 5 is a side view of a light emitting chip in a fifth embodiment of the invention.

FIG. 6 is a side view of another type of keycaps in a sixth embodiment of the invention.

### DETAILED DESCRIPTION OF THE PREFERRED EMBODIMENTS

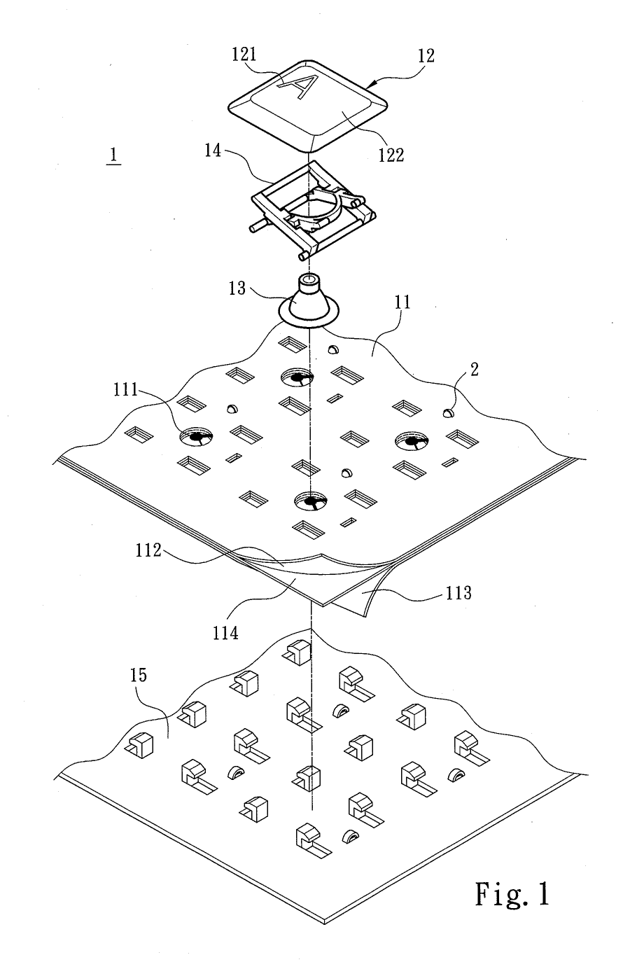

Please refer to FIGS. 1, 2 and 3A, the present invention aims to provide a keyboard equipped with illuminated keycaps. It mainly includes a keyboard portion 1 and a plurality of lighting units 2. The keyboard portion 1 includes a circuit board 11, a plurality of keycaps 12 and a plurality of elastic support members 13 located between the circuit board 11 and the keycaps 12. More specifically, the circuit board 11 includes a plurality of keyboard command portions 111. Each of the keycaps 12 corresponds to the individual keyboard command portion 111. When the keycap 12 is depressed to move towards the circuit board 11, the elastic support member 13 is compressed to trigger the corresponding keyboard command portion 111 to generate a command. The keycaps 12 and elastic support members 13 jointly form a light emitting zone D1. Moreover, each of the lighting units 2 corresponds to one keycap 12, and includes a light emitting chip 21 located on the circuit board 11, a package layer 22 covering the light emitting chip 21 and a light mask layer 23 locally disposed on the package layer 22. The light emitting chip 21 can be a light emitting diode which is directly bonded to the circuit board 11 through welding via a surface mount technology. The position of the light emitting chip 21 can be adjusted as desired, the drawings illustrate merely an example that is not the limitation of the invention. The package layer 22 can be a cooled resin covering the light emitting chip 21 through a dispensing process. After the light emitting chip 21 is powered to generate light, the light transmits the package layer 22. But a portion of the light is masked by the light mask layer 23 and cannot project to the abutting keycap 12, hence the light is confined to project merely to the light emitting zone D1 through the position of the package layer 22 which is not masked by the light mask layer 23. More specifically, the package layer 22 includes a first projection surface 221 facing the corresponding keycap 12 and a second projection surface 222 facing another abutting keycap 12a on another side. The light mask layer 23 can be coated or bonded onto the package layer 22 through a chemical or physical method to mask the second projection surface 222 of the package layer 22 so that the light cannot project to another keycap 12a through the second projection surface 222, but projects only through the unmasked first projection surface 221. The light mask layer 23, aside from the masked second projection surface 222, as the angle of the light projecting to the keycap 12 also can be adjusted as desired, a portion of the first projection surface 221 can be masked to change light projection angle. In addition, the light mask layer 23 can be made of a reflective material or opaque material. Moreover, in order to concentrate the light more intensively to project to the light emitting zone D1, the elastic support member 13 can be made of a light transmission material. Hence when the lighting unit 2 projects light to the light emitting zone D1, the light is first projected to the elastic support member 13 and then transmitted to the keycap 12 for emitting.

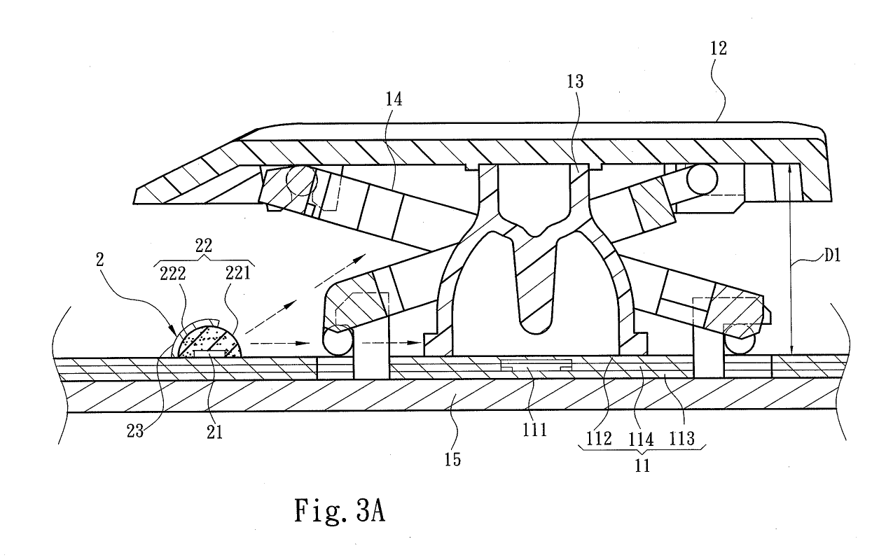

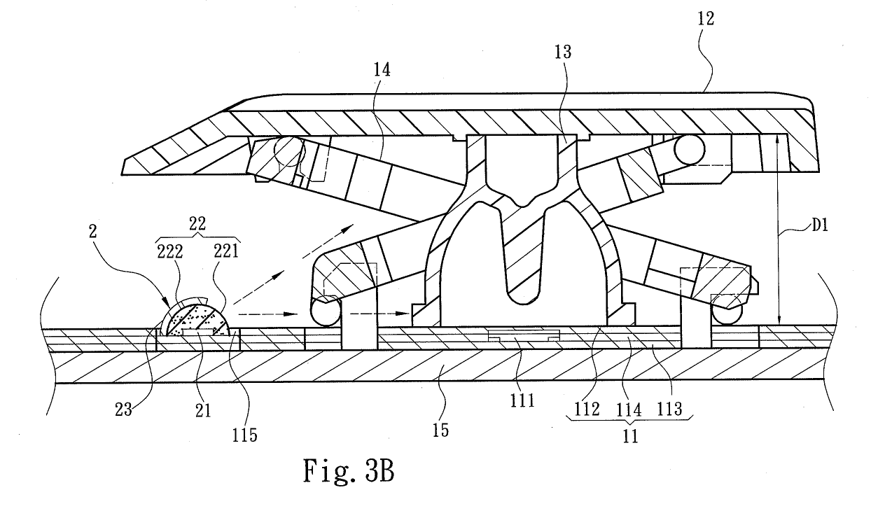

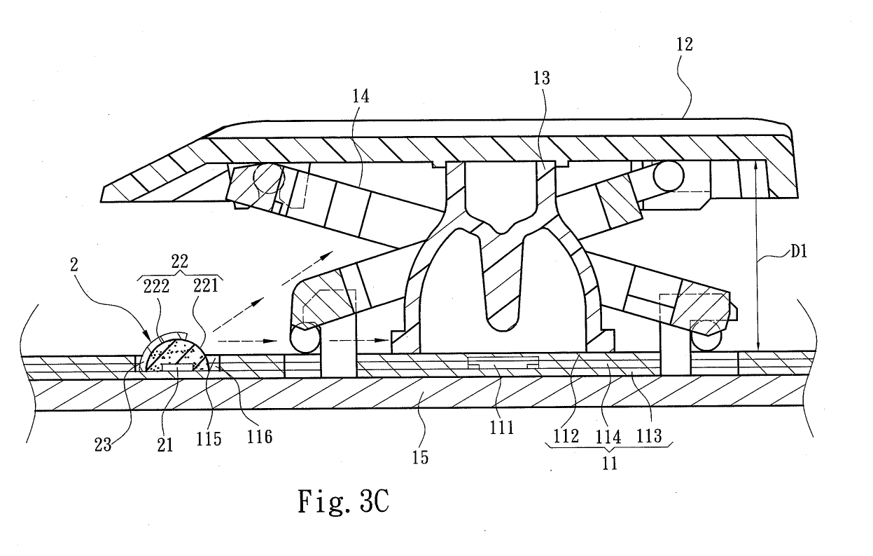

Please refer to FIGS. 3A, 3B and 3C, the circuit board 11 includes an upper film 112, a lower film 113 and a middle film 114 located between the upper film 112 and lower film 113. The upper film 112, lower film 113 and middle film 114 include key circuits (not shown in the drawings) that are interconnected to form the keyboard command portions 111. The light emitting chip 21 can be located on the upper film 112 shown in FIG. 3A, lower film 113 shown in FIG. 3C or middle film 114 shown in FIG. 3B. In the embodiment shown in FIG. 3B, the upper film 112 includes a plurality of first apertures 115 respectively corresponding to the lighting units 2 for holding such that the light emitted from the lighting units 2 projects to the light emitting zone D1 through the first apertures 115. In the embodiment shown in FIG. 3C, the upper film 112 also includes the first apertures 115, and the middle film 114 includes a plurality of second apertures 116 respectively corresponding to the lighting units 2 and communicating with the first apertures 115 for holding the light emitting chip 21.

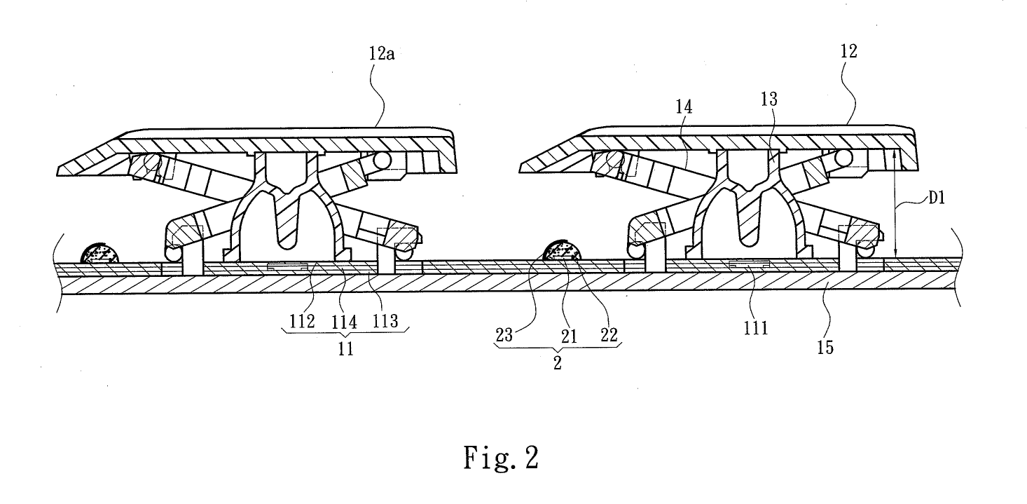

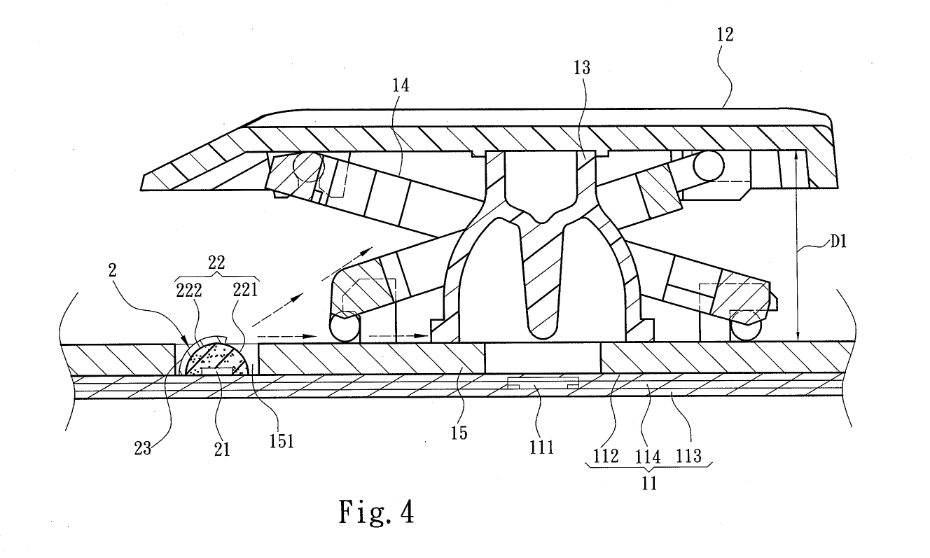

Please refer to FIGS. 2 and 4, in addition to the circuit board 15 and keycaps 12, the keyboard of the present invention further includes a plurality of driven mechanisms 14 and a support board 15. Each driven mechanism 14 supports the keycap 12 and is depressed by the keycap 12 to move. The support board 15 holds the driven mechanisms 14. However, the keyboard of the present invention can be formed in many types. FIG. 2 illustrates one type with the circuit board 11 located above the support board 15; FIG. 4 shows another type with the circuit board 11 located below the support board 15. In the embodiment shown in FIG. 4, the support board 15 includes a plurality of openings 151 respectively corresponding to the lighting units 2 on the circuit board 11 so that the light from the lighting units 2 can project to the light emitting zone D1 through the openings 151.

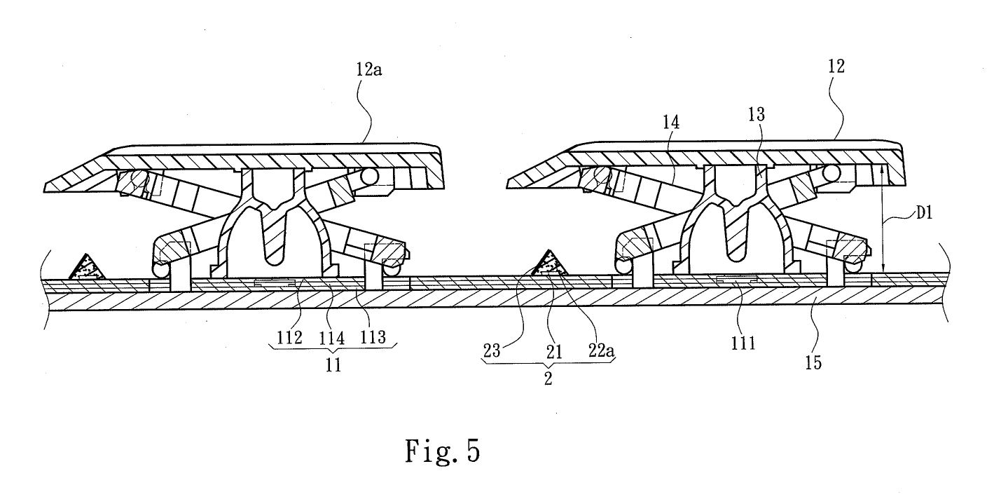

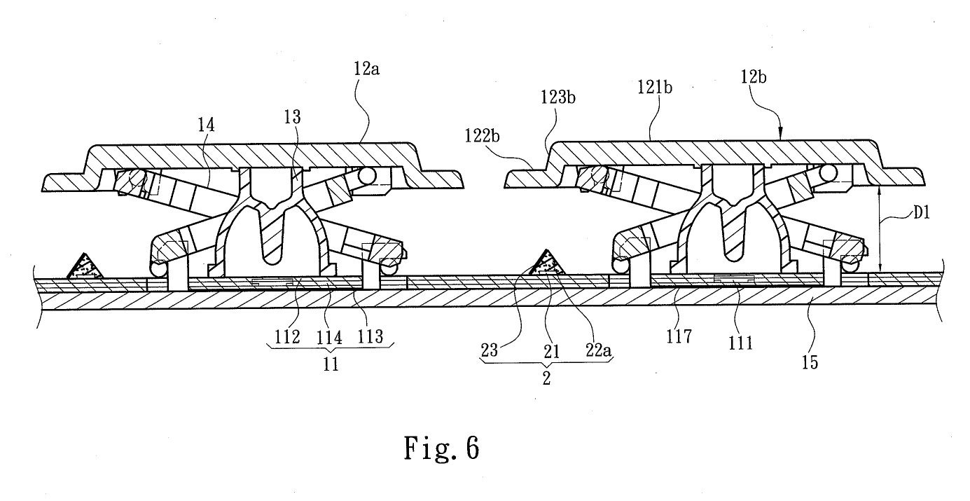

Please refer to FIG. 1, in order to provide uneven illumination effect, the keycap 12 of the present invention further includes a transparent zone 121 and an opaque zone 122. The transparent zone 121 can be a character notation on the keycap 12. Thus when light is projected to the light emitting zone D1, the light not being masked by the opaque zone 122 can emit through the transparent zone 121. On the other hand, the package layer 22 can be formed in a circular or polygonal cross section in a vertical direction. As shown in FIG. 5, the package layer 22a is formed in a polygonal cross section in a vertical direction, such as in a triangular shape. Moreover, the keycaps 12 adopted in the industry mainly can be divided into two types, one is shown in FIG. 3A, the other is shown in FIG. 6 which includes an upper surface 121b for receiving forces, a bottom surface 122b below the upper surface 121b, and an inclined surface 123b bridging the upper surface 121b and bottom surface 122b. In this embodiment, the lighting unit 2 projects light to the upper surface 121b, bottom surface 122b and inclined surface 123b. Furthermore, the circuit board 11 also includes a reflective layer 117 to confine the light from the lighting unit 2 to project merely to the light emitting zone D1, i.e., light from the lighting unit 2 projecting to the circuit board 11 is reflected by the reflective layer 117 to enter the light emitting zone D1. The circuit board 11 can be made of a transparent material, and the reflective layer 117 can be coated or bonded to the circuit board 11 via a physical or chemical method, and located on the upper film 112, lower film 113 or middle film 114.

As a conclusion, the keyboard equipped with illuminated keycaps of the present invention mainly includes a keyboard portion and a plurality of lighting units. The keyboard portion includes a circuit board with a plurality of keyboard command portions, a plurality of keycaps respectively corresponding to the keyboard command portions and a plurality of elastic support members located between the circuit board and keycaps and depressed by the keycaps to trigger the keyboard command portions. The keycaps and elastic support members form a light emitting zone therebetween. The lighting units correspond respectively to one keycap. Each of the lighting units includes a light emitting chip located on the circuit board, a package layer covering the light emitting chip and a light mask layer locally disposed on the package layer to mask light from the light emitting chip towards the abutting keycap such that the light is confined to generate illumination merely in the light emitting zone. The keyboard thus formed can overcome the problems of the conventional illuminated keyboards that cannot be made thinner and cannot provide uniform illumination due to the light guide plate or light guide strip. Fabrication process of the keyboard of the invention also is simplified and the keyboard structure is simpler.

While the preferred embodiments of the invention have been set forth for the purpose of disclosure, they are not the limitation of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A keyboard equipped with illuminated keycaps, comprising:
a keyboard portion including a circuit board with a plurality of keyboard command portions, a plurality of keycaps respectively corresponding to the keyboard command portions and a plurality of elastic support members located between the circuit board and the keycaps and depressed by the keycaps to trigger the keyboard command portions; the keycaps and the elastic support members forming a light emitting zone therebetween; and
a plurality of lighting units respectively corresponding to each of the keycaps, each of the lighting units including a light emitting chip located on the circuit board, a package layer covering the light emitting chip and a light mask layer locally disposed on the package layer to mask light from the light emitting chip towards the abutting keycap such that the light is confined to generate illumination merely in the light emitting zone.

2. The keyboard equipped with illuminated keycaps of claim 1, wherein the circuit board includes an upper film, a lower film and a middle film located between the upper film and the lower film.

3. The keyboard equipped with illuminated keycaps of claim 2, wherein the lighting units are located on the upper film.

4. The keyboard equipped with illuminated keycaps of claim 2, wherein the lighting units are located on the middle film, the upper film including a plurality of first apertures respectively corresponding to the lighting units for holding.

5. The keyboard equipped with illuminated keycaps of claim 2, wherein the lighting units are located on the lower film, the upper film including a plurality of first apertures respectively corresponding to the lighting units, the middle film including a plurality of second apertures respectively corresponding to the lighting units and communicating with the first apertures to hold the lighting units.

6. The keyboard equipped with illuminated keycaps of claim 1, wherein the circuit board includes a reflective layer to confine the lighting units to project the light merely to the light emitting zone.

7. The keyboard equipped with illuminated keycaps of claim 1, wherein the light mask layer is made of an opaque material.

8. The keyboard equipped with illuminated keycaps of claim 1, wherein the light mask layer is made of a light reflective material.

9. The keyboard equipped with illuminated keycaps of claim 1, wherein the package layer is formed in a circular cross section in a vertical direction.

10. The keyboard equipped with illuminated keycaps of claim 1, wherein the package layer is formed in a polygonal cross section in a vertical direction.

11. The keyboard equipped with illuminated keycaps of claim 1, wherein the elastic support members are made of a light transmission material.

12. The keyboard equipped with illuminated keycaps of claim 1, wherein each of the keycaps includes a transparent zone and an opaque zone.

13. The keyboard equipped with illuminated keycaps of claim 1, wherein the keyboard portion further includes a plurality of driven mechanisms to respectively support the keycaps and depressed by the keycaps, and a support board to hold the plurality of driven mechanisms.

14. The keyboard equipped with illuminated keycaps of claim 13, wherein the circuit board is located above the support board.

15. The keyboard equipped with illuminated keycaps of claim 13, wherein the circuit board is located below the support board which includes a plurality of openings respectively corresponding to the lighting units.
